(19) United States
(12) Patent Application Publication
(10) Pub. No.: US 2006/0038408 A1
(43) Pub. Date: Feb. 23, 2006

(54) Cover

(75) Inventors: Hideo Yamaguchi, Niigata (JP); Akira Ishiguchi, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 11/073,598

(22) Filed: Mar. 8, 2005

(30) Foreign Application Priority Data
Aug. 20, 2004 (JP) P.2004-241525

(51) Int. Cl. E05C 19/10

(52) U.S. Cl. 292/101

(57) ABSTRACT

A cover includes an inner cover and an outer cover. The inner cover is fastened to a frame of an image forming apparatus and has integrally formed reinforcing ribs for improving strength and at least one outer cover mounting part. The outer cover has at least one mounted part which is mounted to the outer cover mounting part and possesses an outer surface which is exposed to the outside when the mounted part is mounted to the outer cover mounting part.

### BACKGROUND OF THE INVENTION

1. Field of the Invention

The present invention relates to a cover for an image forming apparatus such as a printer, a FAX, a copying machine, and the like, and more particularly, to a cover which has a decorative design on an outer surface exposed to the outside so that a user can view the decorative design.

2. Background Art

As a conventional art for a cover of an image forming apparatus such as a printer, a FAX, a copying machine, and the like, the following techniques have been disclosed.

In JP-A-8-234521, there is described an opening and closing cover. The opening and closing cover has an outer cover 50 which is formed with a plurality of ribs 50Y and is openably hinged to a body of an apparatus, and an inner cover 60 which is formed integrally with functional members 50a and 50c and is mounted to the inside of the outer cover 50.

In JP-A-2004-34648, there is described a side cover which is formed on an inner surface thereof with fastening clips 1a, 1c, 50a and 50c and reinforcing ribs 11 and 1m.

In general, the covers of JP-A-8-234521 and JP-A-2004-34648 are integrally formed of resin by using molds as in the case of an injection molding method, etc. If ribs or functional members are formed on the inner surfaces of the covers as disclosed in JP-A-8-234521 and JP-A-2004-34648, indentations are likely to be formed on the outer surfaces of the covers. Since the outer surface of the outer cover and the inner surface of the inner cover in JP-A-8-234521 and the outer surface of the cover in JP-A-2004-34648 are viewed by a user, if the indentations are formed on the surfaces of the cover, aesthetics of an outer appearance is deteriorated. Therefore, in JP-A-8-234521 and JP-A-2004-34648, in order to ensure that indentations are not formed (or not viewed), it is necessary to decrease the thickness of the ribs and functional members (especially, a thickness of distal end portions of the ribs and functional members), and limitations necessarily exist in determining the locations and the number of the ribs. If the thickness of the ribs is decreased or the locations and the number of the ribs are limited, it is impossible to properly reinforce the cover, whereby insufficient strength of the cover may result.

Also, although it can be envisaged to increase the number of ribs to thereby improve the strength of the cover, since positions for locating the ribs are restrained, positions for locating the functional members can be further restrained. Consequently, if the number of ribs is increased to secure the strength of the cover, difficulties may be caused in the manufacture of the cover, and design freedom in positioning of the functional members, etc. is decreased. Further, since the thickness of the functional members is limited as well, it may be impossible to secure the strength of the functional members in a sufficient manner.

Moreover, in the case that the outer surface of the cover is damaged or broken, because the entire cover must be changed, waste of material is caused and material reutilization efficiency is deteriorated. Furthermore, in consideration of the fact that an image fixing device having a heater which is heated when forming an image may be maintained under a high temperature or an inside of the image forming apparatus may be maintained under a high temperature due to breakdown of a control board, for the sake of safety, it may be necessary to manufacture the ribs, etc. using a flame retarding material. Therefore, limitations further exist in materials for forming the cover.

Due to these limitations in positioning of the ribs and materials for forming the ribs, design freedom for rendering an aesthetic outer appearance is decreased. In addition, in JP-A-8-234521 and JP-A-2004-34648, in the case of forming fastening clips or functional members integrally with the cover, aesthetics of an outer appearance is deteriorated when rapping holes for rapping are formed in the cover. Thus, when integrally forming a part having an undercut shape such as the fastening clips, specific molds are needed, and therefore, a manufacturing cost is increased.

### SUMMARY OF THE INVENTION

Accordingly, the present invention has been made to overcome the above-mentioned defects of the conventional techniques, and objects of the present invention are to improve strength of a cover while preventing an outer appearance of the cover from being deteriorated due to the presence of indentations, and to elevate design freedom or decoration freedom of the cover.

Next, the present invention which overcomes the aforementioned defects will be described. In this description, component elements according to the present invention will be accompanied by bracketed reference numerals or symbols, for easy reference to the corresponding component elements according to a preferred embodiment of the present invention which will be described later in detail. Another reason to the usage of the bracket reference numerals in the description of the component elements is for easy understanding of the present invention, and therefore, it is to be readily understood that the scope of the present invention is not limited to the preferred embodiment.

(The Present Invention)

In order to achieve the above objects, according to the present invention, there is provided a cover including: (A01) an inner cover (FC2, RC2) for an image forming apparatus (U), having integrally formed reinforcing ribs (26, 66) for improving strength and at least one outer cover mounting part (17, 23, 62); and (A02) an outer cover (FC1, RC1) having at least one mounted part (3, 8, 46) which is mounted to the outer cover mounting part (17, 23, 62), the outer cover (FC1, RC1) possessing an outer surface which is exposed to the outside when the mounted part (3, 8, 46) is mounted to the outer cover mounting part (17, 23, 62).

(Operation of the Present Invention)

In the cover according to the present invention, which includes the components (A01) and (A02), the inner cover (FC2, RC2) has the integrally formed reinforcing ribs (26, 66) for improving strength. The outer cover (FC1, RC1) having the mounted part (3, 8, 46) which is mounted to the outer cover mounting part (17, 23, 62) possesses the outer surface which is exposed to the outside when the mounted part (3, 8, 46) is mounted to the outer cover mounting part (17, 23, 62). Accordingly, since the outer cover (FC1, RC1) is mounted to the inner cover (FC2, RC2), even when indentations are formed on the inner cover (FC2, RC2) due to the presence of the reinforcing ribs (26, 66) formed integrally with the inner cover (FC2, RC2), the indentations are covered by the outer cover (FC1, RC1). As a result, in the cover of the present invention, an outer appearance of the cover is not deteriorated by the presence of the indentations, and it is possible to improve strength of the cover. Therefore, because it is possible to design the cover without paying attention to the indentations, design freedom can be elevated. Also, due to the fact that the outer cover (FC1, RC1) and the inner cover (FC2, RC2) include separate members, the outer cover (FC1, RC1) can be made of a material which is different from that of the inner cover (FC2, RC2), as occasion demands, whereby it is possible to elevate decoration freedom for the outer cover (FC1, RC1). Further, since the outer cover (FC1, RC1) is mounted to the inner cover (FC2, RC2), only the outer cover (FC1, RC1) can be changed, whereby waste of material is avoided and material reutilization efficiency is improved.

(First Aspect of the Present Invention)

A first aspect of the present invention is directed for the cover according to the present invention, including: (A03) the inner cover (FC2, RC2) formed by molding.

(Operation of First Aspect of Present Invention)

In the cover according to the first aspect of the present invention, which includes the component (A03), the inner cover (FC2, RC2) is formed by molding.

(Second Aspect of the Present Invention)

A second aspect of the present invention is directed for the cover according to the present invention or the first aspect of the present invention, including: (A04) the inner cover (FC2, RC2) made of resin.

(Operation of Second Aspect of Present Invention)

In the cover according to the second aspect of the present invention, which includes the component (A04), the inner cover (FC2, RC2) is made of resin.

(Third Aspect of the Present Invention)

A third aspect of the present invention is directed for the cover according to any one of the present invention and the first and second aspects of the present invention, including: (A05) the outer cover (FC1, RC1) having the mounted part (8, 46) which is defined with a threaded hole (8, 46); and (A06) the inner cover (FC2, RC2) having the outer cover mounting part (23, 62) which is defined with a screw passage hole (23, 62) so that the outer cover (FC1, RC1) can be mounted to the inner cover (FC2, RC2) by a screw (31) which passes through the screw passage hole (23, 62) and the threaded hole (8, 46) from the inside of the inner cover (FC2, RC2).

(Operation of Third Aspect of the Present Invention)

In the cover according to the third aspect of the present invention, which includes the components (A05) and (A06), the mounted part (8, 46) of the outer cover (FC1, RC1) includes the threaded hole (8, 46). The outer cover mounting part (23, 62) of the inner cover (FC2, RC2) includes the screw passage hole (23, 62). The outer cover (FC1, RC1) is mounted to the inner cover (FC2, RC2) by the screw (31) which passes through the screw passage hole (23, 62) and the threaded hole (8, 46) from the inside of the inner cover (FC2, RC2).

(Fourth Aspect of the Present Invention)

A fourth aspect of the present invention is directed for the cover according to any one of the present invention and the first through third aspects of the present invention, including: (A07) the inner cover (FC2, RC2) having the outer cover mounting part (17) which includes a snap-fit engaging part (17); and (A08) the outer cover (FC1, RC1) having the mounted part (3) which includes a snap-fit engaged part (3) so that the outer cover (FC1, RC1) can be mounted to the inner cover (FC2, RC2) through engagement of the snap-fit engaged part (3) with the snap-fit engaging part (17) when the outer cover (FC1, RC1) is overlapped with the inner cover (FC2, RC2).

(Operation of Fourth Aspect of the Present Invention)

In the cover according to the fourth aspect of the present invention, which includes the components (A07) and (A08), the outer cover mounting part (17) of the inner cover (FC2, RC2) includes the snap-fit engaging part (17). The mounted part (3) of the outer cover (FC1, RC1) includes the snap-fit engaged part (3). AS a consequence, when the outer cover (FC1, RC1) is overlapped with the inner cover (FC2, RC2), the snap-fit engaged part (3) is engaged with the snap-fit engaging part (17), whereby the outer cover (FC1, RC1) is mounted to the inner cover (FC2, RC2).

(Fifth Aspect of the Present Invention)

A fifth aspect of the present invention is directed for the cover according to any one of the present invention and the first through fourth aspects of the present invention, including: (A09) the outer cover (FC1, RC1) covering a substantially entire surface of the inner cover (FC2, RC2) when the outer cover (FC1, RC1) is mounted to the inner cover (FC2, RC2).

(Operation of Fifth Aspect of the Present Invention)

In the cover according to the fifth aspect of the present invention, which includes the component (A09), the outer cover (FC1, RC1) covers a substantially entire surface of the inner cover (FC2, RC2) when the outer cover (FC1, RC1) is mounted to the inner cover (FC2, RC2).

(Sixth Aspect of the Present Invention)

A sixth aspect of the present invention is directed for the cover according to any one of the present invention and the first through fifth aspects of the present invention, including: (A10) the inner cover (FC2) defined with rapping holes (29) for rapping during integral formation.

(Operation of Sixth Aspect of Present Invention)

In the cover according to the sixth aspect of the present invention, which includes the component (A10), the inner cover (FC2) is defined with the rapping holes (29) for rapping during integral formation.

(Seventh Aspect of the Present Invention)

A seventh aspect of the present invention is directed for the cover according to any one of the present invention and the first through sixth aspects of the present invention, including: (A11) the inner cover (FC2, RC2) fastened to a frame of the image forming apparatus (U) with the outer cover (FC1, RC1) mounted to the inner cover (FC2, RC2).

(Operation of Seventh Aspect of Present Invention)

In the cover according to the seventh aspect of the present invention, which includes the component (A11), the inner cover (FC2, RC2) is fastened to the frame of the image forming apparatus (U) with the outer cover (FC1, RC1) mounted to the inner cover (FC2, RC2).

(Eighth Aspect of the Present Invention)

An eighth aspect of the present invention is directed for the cover according to any one of the present invention and the first through seventh aspects of the present invention, including: (A12) the inner cover (FC2, RC2) defined at an outer end (12, 52) thereof with frame-fastening threaded holes (14, 54) into which screws for fastening the inner cover (FC2, RC2) to the frame are threadably coupled.

(Operation of Eighth Aspect of Present Invention)

In the cover according to the eighth aspect of the present invention, which includes the component (A12), the inner cover (FC2, RC2) is defined at the outer end (12, 52) thereof with the frame-fastening threaded holes (14, 54) into which screws for fastening the inner cover (FC2, RC2) to the frame are threadably coupled.

(Ninth Aspect of the Present Invention)

A ninth aspect of the present invention is directed for the cover according to any one of the present invention and the first through eighth aspects of the present invention, including: (A13) the inner cover (FC2) having a part support section (27) for supporting parts which constitute the image forming apparatus (U).

(Operation of Ninth Aspect of the Present Invention)

In the cover according to the ninth aspect of the present invention, which includes the component (A13), the inner cover (FC2) has the part support section (27) for supporting the parts which constitute the image forming apparatus (U).

(Tenth Aspect of the Present Invention)

A tenth aspect of the present invention is directed for the cover according to any one of the present invention and the first through ninth aspects of the present invention, including: (A14) the outer cover (FC1) covering an outer surface portion of the inner cover (FC2), which corresponds to a position where the part support section (27) is installed.

(Operation of Tenth Aspect of the Present Invention)

In the cover according to the tenth aspect of the present invention, which includes the component (A14), the outer cover (FC1) covers the outer surface portion of the inner cover (FC2), which corresponds to the position where the part support section (27) is installed. Accordingly, even when indentations are formed due to the presence of the part support section (27), the outer cover (FC1) can reliably cover the indentations.

(Eleventh Aspect of the Present Invention)

An eleventh aspect of the present invention is directed for the cover according to any one of the present invention and the first through tenth aspects of the present invention, including: (A15) the inner cover (FC2, RC2) having the reinforcing ribs (26, 66) which have a thickness thicker than that of the outer cover (FC1, RC1).

(Operation of Eleventh Aspect of the Present Invention)

In the cover according to the eleventh aspect of the present invention, which includes the component (A15), the inner cover (FC2, RC2) has the reinforcing ribs (26, 66) of the inner cover (FC2, RC2) have a thickness thicker than that of the outer cover (FC1, RC1). Therefore, without paying attention to the indentations, the reinforcing ribs (26, 66) can be formed on the inner cover (FC2, RC2) which is covered by the outer cover (FC1, RC1), to have a sufficient thickness. Also, the outer cover (FC1, RC1) which is mounted to the inner cover (FC2, RC2) can be decreased in its thickness.

(Twelfth Aspect of the Present Invention)

A twelfth aspect of the present invention is directed for the cover according to any one of the present invention and the first through eleventh aspects of the present invention, including: (A16) the outer cover (FC1, RC1) covering indentations which are formed on an outer surface of the inner cover (FC2, RC2) due to the presence of the integrally formed reinforcing ribs (26, 66).

(Operation of Twelfth Aspect of the Present Invention)

In the cover according to the twelfth aspect of the present invention, which includes the component (A16), the outer cover (FC1, RC1) covers the indentations which are formed on the outer surface of the inner cover (FC2, RC2) due to the presence of the integrally formed reinforcing ribs (26, 66). Therefore, since at least the outer surface portions of the inner cover (FC2, RC2) on which the indentations are formed can be reliably covered by the outer cover (FC1, RC1), aesthetics of an outer appearance of the cover can be improved.

(Thirteenth Aspect of the Present Invention)

A thirteenth aspect of the present invention is directed for the cover according to any one of the present invention and the first through twelfth aspects of the present invention, including: (A17) the inner cover (FC2, RC2) having a threaded boss which is defined with a threaded hole for mounting the inner cover (FC2, RC2) to the image forming apparatus (U); and (A18) the outer cover (FC1, RC1) covering an outer surface portion of the inner cover (FC2, RC2), which corresponds to a position where the threaded boss is formed.

(Operation of Thirteenth Aspect of the Present Invention)

In the cover according to the thirteenth aspect of the present invention, which includes the components (A17) and (A18), the inner cover (FC2, RC2) has the threaded boss which is defined with the threaded hole for mounting the inner cover (FC2, RC2) to the image forming apparatus (U). The outer cover (FC1, RC1) covers the outer surface portion of the inner cover (FC2, RC2), which corresponds to the position where the threaded boss is formed. Therefore, because it is possible to reliably cover the outer surface portion of the inner cover (FC2, RC2), which correspond to the position where the threaded boss is formed and thereby an indentation is likely to be formed, using the outer cover (FC1, RC1), a size, a position, etc. of the threaded boss can be freely designed.

The present invention provides the following advantages.

(E01) It is possible to prevent an outer appearance of the cover from being deteriorated due to the presence of the indentations and to improve strength of the cover.

(E02) Design freedom and decoration freedom for the cover can be elevated.

(E03) In the case that the outer cover is damaged, since only the outer cover can be changed, material reutilization efficiency can be improved.

(E04) When undercut portions are formed integrally on the inner cover, since it is possible to freely define rapping holes, specific molds are not needed, whereby a manufacturing cost of the cover can be reduced.

### BRIEF DESCRIPTION OF THE DRAWINGS

These and other objects and advantages of this invention will become more fully apparent from the following detailed description taken with the accompanying drawings in which:

FIG. 1 is a perspective view illustrating an image forming apparatus in accordance with a preferred embodiment of the present invention;

FIG. 2 is an explanatory view illustrating the entire construction of the image forming apparatus according to the present invention;

FIG. 3 is a perspective view illustrating a front cover which constitutes a cover of the image forming apparatus according to the present invention;

FIG. 4 is a perspective view taken by seeing the front cover in the direction indicated by the arrow IV;

FIGS. 5A and 5B are exploded perspective views of the front cover, wherein FIG. 5A is an explanatory perspective view illustrating an outer cover, and FIG. 5B is an explanatory perspective view illustrating an inner cover;

FIGS. 6A to 6C are explanatory exploded perspective views taken by seeing the front cover from the rear, wherein FIG. 6A is an explanatory perspective view illustrating the inner cover, and FIG. 6B is an explanatory perspective view illustrating the outer cover, and FIG. 6C is an enlarged view for a VIC portion in FIG. 6B;

FIGS. 7A and 7B are enlarged views illustrating a snap-fit engaging part of the front cover, wherein FIG. 7A is an explanatory view illustrating an engaged state of the snap-fit engaging part, and FIG. 7B is an explanatory view illustrating a disengaged state of the snap-fit engaging part;

FIG. 8 is a perspective view illustrating a rear cover which constitutes the cover of the image forming apparatus according to the present invention;

FIG. 9 is a perspective view taken by seeing the rear cover in the direction indicated by the arrow IX;

FIGS. 10A and 10B are exploded perspective views of the rear cover, wherein FIG. 10A is an explanatory perspective view illustrating an outer cover, and FIG. 10B is an explanatory perspective view illustrating an inner cover; and

FIGS. 11A and 11B are explanatory exploded perspective views taken by seeing the rear cover from the rear, wherein FIG. 11A is an explanatory perspective view illustrating the outer cover, and FIG. 11B is an explanatory perspective view illustrating the inner cover.

### DETAILED DESCRIPTION OF THE PREFERRED EMBODIMENTS

Hereinafter, a preferred embodiment of the present invention will be described with reference to the accompanying drawings. However, it is to be noted that the present invention is not limited to the following embodiment.

For easy understanding of the description, in the drawings, forward and rearward directions are referred to as X axis directions, leftward and rightward directions are referred to as Y axis directions, and upward and downward directions are referred to as Z axis directions. Further, the directions or sides which are indicated by the arrows X, −X, Y, −Y, Z and −Z are referred to as forward, rearward, rightward, leftward, upward and downward directions, or front, rear, right, left, upper and lower sides respectively.

Also, in the drawings, the symbol ⊙ indicates the arrow which extends from the inside of the drawing paper toward the outside of the drawing paper, and the symbol \textcircled{×} indicates the arrow which extends from the outside of the drawing paper toward the inside of the drawing paper.

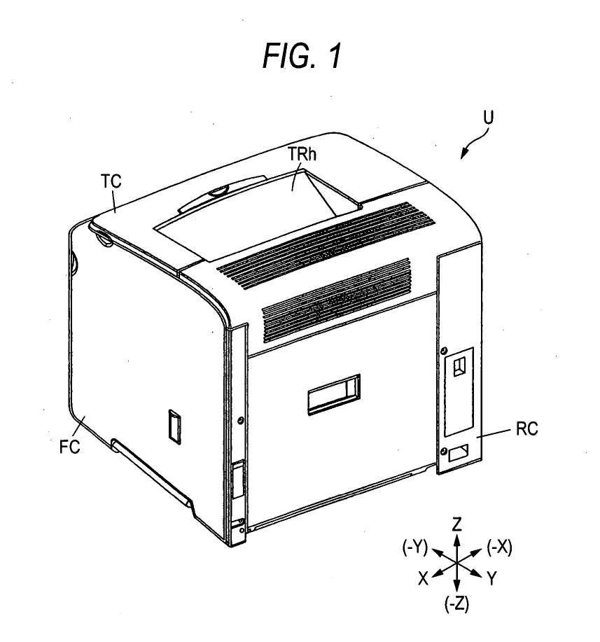

FIG. 1 is a perspective view illustrating an image forming apparatus in accordance with a preferred embodiment of the present invention.

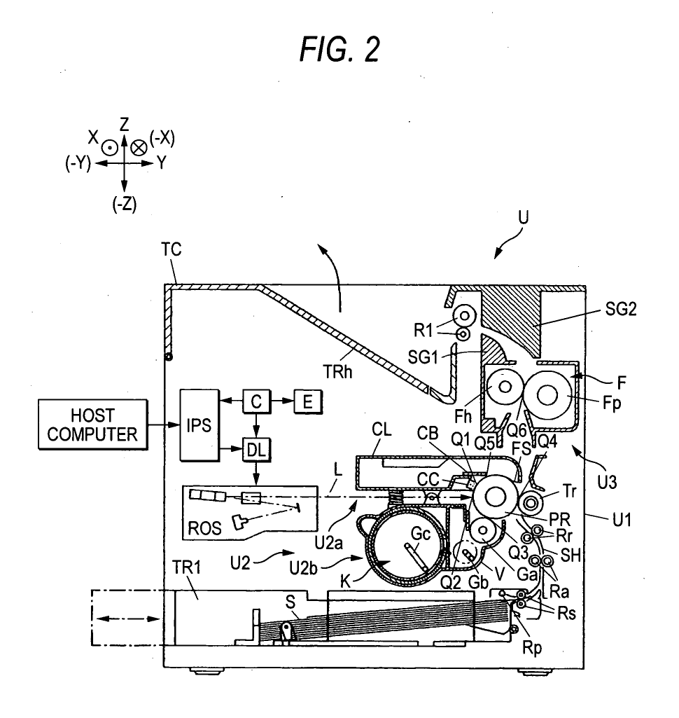

FIG. 2 is an explanatory view illustrating the entire construction of the image forming apparatus according to the present invention.

In FIG. 1, on the upper surface of a printer U which constitutes an image forming apparatus according to a preferred embodiment of the present invention, there is installed a paper discharge tray TRh. A paper feed tray TR1 is provided to a left lower portion of the printer U so that it can be extended out of and retracted into the printer U in the leftward and rightward directions (Y axis directions) (see FIG. 2). In FIGS. 1 and 2, the printer U has a front cover FC and a rear cover RC each of which serves as a cover fastened to a frame, and a top cover TC which can be pivoted about a hinge shaft (see FIG. 2) in the leftward direction (−Y direction).

In FIG. 2, the printer U which constitutes the image forming apparatus according to the preferred embodiment of the present invention further has a printer body U1, a process cartridge U2 which is detachably supported with respect to the printer body U1, and a fixing unit U3.

The printer body U1 includes a controller C constituted by a microcomputer, an image processing system (IPS) of which operation is controlled by the controller C, a laser driving circuit DL, and a power device E. The power device E applies voltages to a charge device CC, a developing roll Ga, and a transfer roll Tr, and so forth, which will be described later.

The IPS converts the printing data externally inputted from a host computer, etc. into image data for forming a latent image and then outputs the converted image data to the laser driving circuit DL at a predetermined timing. The laser driving circuit DL outputs a driving signal to an ROS (latent image forming device) in response to the inputted image data.

The process cartridge U2 includes an image support unit U2a and a developing unit U2b. The image support unit U2a of the process cartridge U2 has an image support PR, the charge device CC, and a toner recovery container (cleaner) CL for rotatably supporting the image supporter PR and the charge device CC. The developing unit U2b has a developing container V. In the developing container V, the developing roll Ga and a developer agitating member Gb are rotatably supported. A developer cartridge K is detachably mounted to the developing container V. An agitation and delivery member Gc, which delivers developer to the developer agitating member Gb while agitating the developer, is rotatably supported in the developer cartridge K.

The surface of the image support PR which rotates is charged by the charge device (scorotron) CC in a charge region Q1, and is recorded with an electrostatic latent image by the laser beam L which is emitted from the ROS (latent image recording device), in a latent image recording position Q2. The electrostatic latent image is developed into a toner image by the developing roll Ga of the developing unit U3b in a developing region Q3, and then, is transferred to a recording paper S by the transfer roll Tr in a transfer region Q4 which is defined due to the contact between the image support PR and the transfer roll Tr. The toner remaining on the surface of the image support PR is removed (rubbed away) by a cleaning blade CB in a cleaning region Q5 which is defined downstream of the transfer region Q4, and then, is recovered to the toner recovery container CL.

A film seal FS is formed opposite to the cleaning blade CB. The film seal FS functions to prevent the toner recovered into the toner recovery container CL from overflowing to the outside.

A recording paper S, which is taken out by a pick-up roll Rp from the paper feed tray TR1 provided to the lower portion of the printer body U1, is separated one paper at a time by a handling roll device RS which has a retard roll and a paper feed roll, and then, is transported by a paper transport roll Ra which is disposed in a paper transport passage SH and then by a registration roll Rr which is located upstream in a paper transport direction toward the transfer region Q4, to the transfer region Q4 at a predetermined timing.

The transfer roll Tr which a transfer bias is applied at a predetermined timing from the power device E controlled by the controller C transfers the toner image existing on the image support PR to the recording paper S which passes through the transfer region Q4.

The recording paper S to which the toner image is transferred in the transfer region Q4 is transported to the fixing unit U3 in a state in which the toner image is not fixed. The fixing unit U3 has a fixing device F which is composed of a pair of fixing rolls Fh and Fp. A fixing region Q6 is defined due to the contact between the pair of fixing rolls Fh and Fp. The recording paper S which is transported to the fixing unit U3 is fixed with the toner image in the fixing region Q6 by the pair of fixing rolls Fh and Fp of the fixing device F. The recording paper S which is fixed with the toner image is guided by paper guides SG1 and SG2, and then, is discharged from a discharge roll R1 toward the paper discharge tray TRh which is installed on the upper surface of the printer body U1.

(Description of Cover)

(Description of Front Cover)

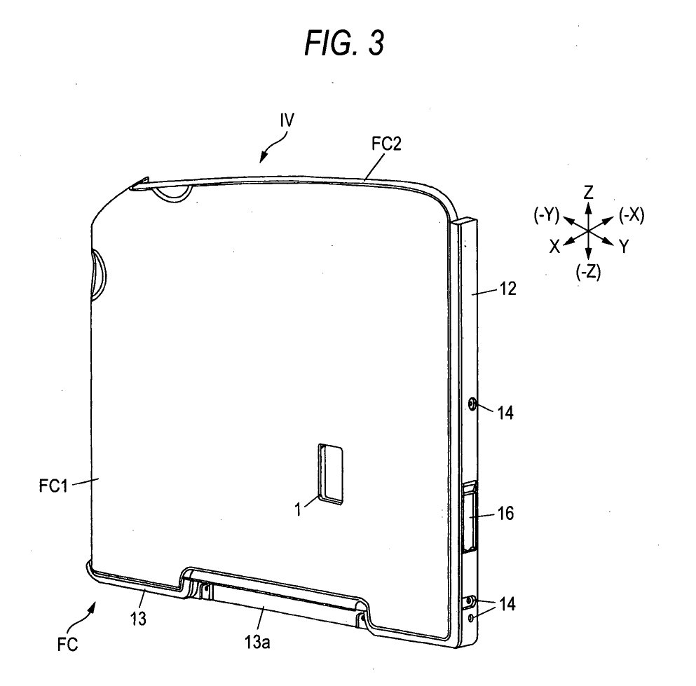

FIG. 3 is a perspective view illustrating a front cover which constitutes a cover of the image forming apparatus according to the present invention.

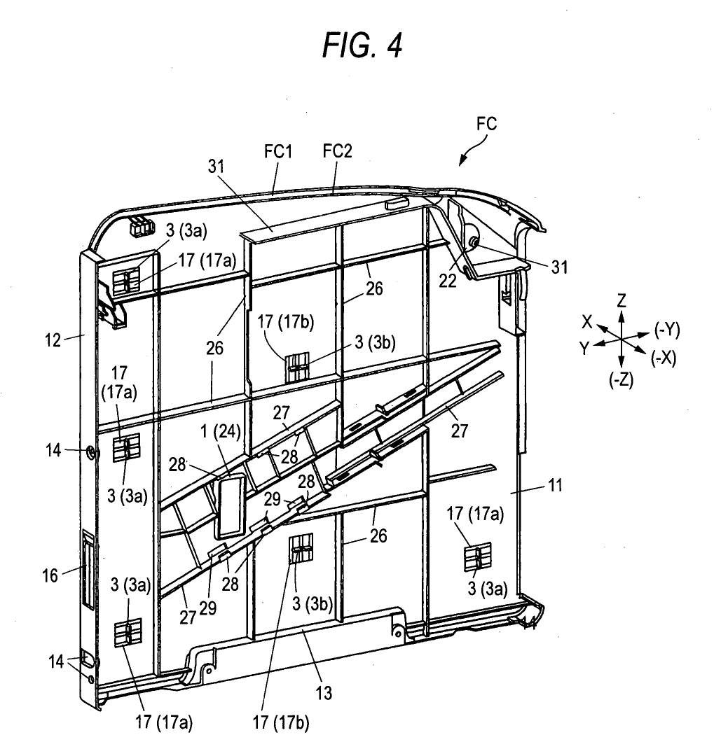

FIG. 4 is a perspective view taken by seeing the front cover in the direction indicated by the arrow IV.

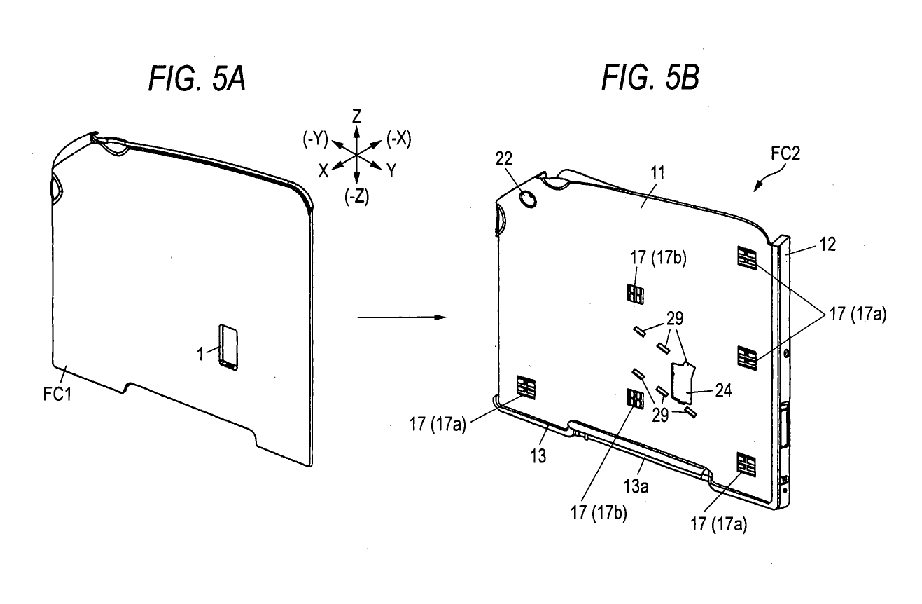

FIGS. 5A and 5B are exploded perspective views of the front cover, wherein FIG. 5A is an explanatory perspective view illustrating an outer cover, and FIG. 5B is an explanatory perspective view illustrating an inner cover.

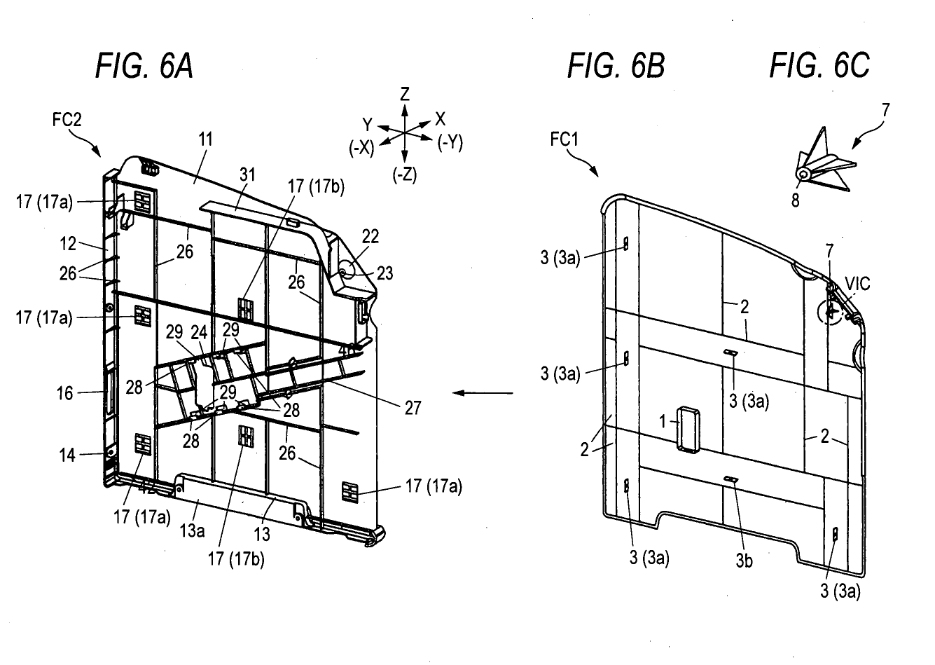

FIGS. 6A to 6C are explanatory exploded perspective views taken by seeing the front cover from the rear, wherein FIG. 6A is an explanatory perspective view illustrating the inner cover, and FIG. 6B is an explanatory perspective view illustrating the outer cover, and FIG. 6C is an enlarged view for a VIC portion in FIG. 6B.

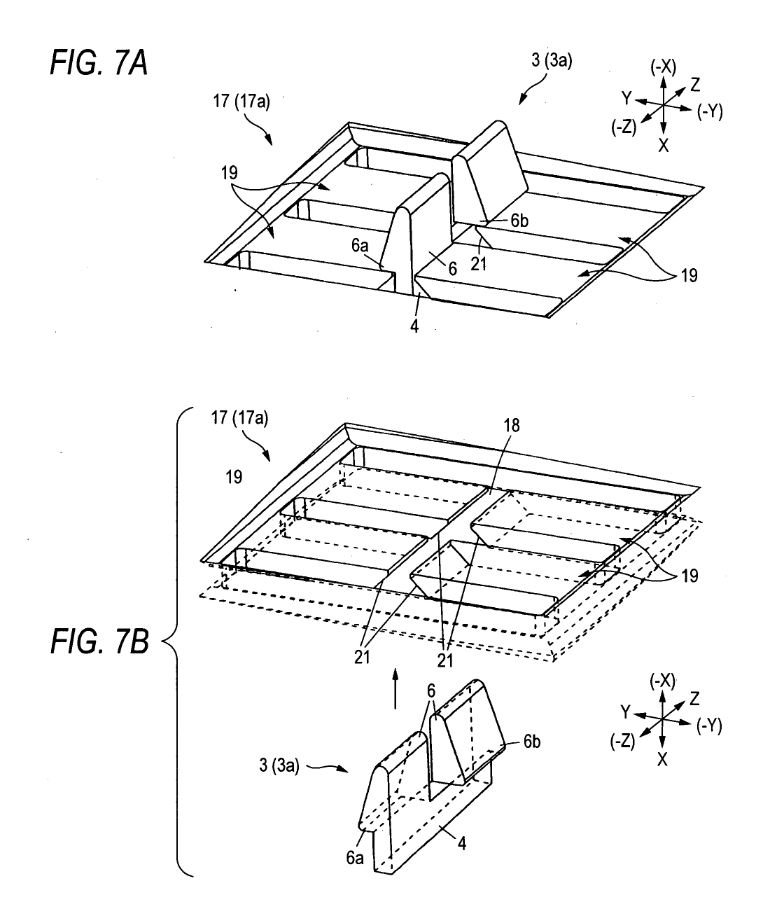

FIGS. 7A and 7B are enlarged views illustrating a snap-fit engaging part of the front cover, wherein FIG. 7A is an explanatory view illustrating an engaged state of the snap-fit engaging part, and FIG. 7B is an explanatory view illustrating a disengaged state of the snap-fit engaging part.

In FIGS. 1, and 3 through 6, the front cover FC of the printer U includes a front decorative cover FC1 which serves as an outer cover and a front strength maintaining cover FC2 which serves as an inner cover. In FIGS. 5A and 6B, the front decorative cover FC1 has an outer operation window 1 which is defined through the front decorative cover FC1 in the forward and rearward directions. A plurality of reinforcing ribs 2 are formed on the rear surface of the front decorative cover FC1, and have a small size so that indentations are not formed on the outer surface of the front decorative cover FC1. Also, a plurality of snap-fit engaged parts (mounted parts) 3 which extend rearward further than the reinforcing ribs 2 are formed integrally on the rear surface of the front decorative cover FC1. While the plurality of snap-fit engaged parts 3 have the same configurations, the snap-fit engaged parts 3a which are located at right and left sides of the front decorative cover FC1 are formed in the upward and downward directions, and the snap-fit engaged parts 3b which are located at the center portion of the front decorative cover FC1 are formed in the leftward and rightward directions.

In FIGS. 7A and 7B, each snap-fit engaged part 3a has a projecting body 4 which projects rearward, and clip bodies 6 which extend rearward from the upper and lower portions of the projecting body 4 and are capable of elastic deformation. As shown in FIG. 7B, a clip portion 6a of the lower (−Z side) clip body 6 is formed to project in the rightward direction (+Y direction), and a clip portion 6b of the upper (+Z side) clip body 6 is formed to project in the leftward direction (−Y direction).

Referring to FIG. 6B, a threaded boss 7 is formed integrally on the left upward portion (−Y+Z portion) of the front decorative cover FC1. Referring to FIG. 6C, the threaded boss 7 is defined with a threaded hole (mounted part) 8 which extends in the forward and rearward directions.

Referring to FIGS. 3 through 6, the front strength maintaining cover FC2 has a plate-shaped cover body 11, a right end wall 12 (an outer side end) which extends rearward from the right end (the outer end) of the cover body 11, and an edge part 13 which is integrally formed along the lower end of the cover body 11 and projects forward by the thickness of the front decorative cover FC1 in conformity with the contour of the lower edge of the front decorative cover FC1. The right end wall 12 is defined with frame-fastening threaded holes 14 and an access window 16. A grip portion 13a is formed on the center portion of the edge part 13 so that a user can grip the grip portion 13a when lifting up the printer U.

Referring to FIGS. 5B and 6, the cover body 11 is formed with a plurality of snap-fit engaging parts (outer cover mounting parts) 17 (17a and 17b) at positions which respectively correspond to the snap-fit engaged parts 3 (3a and 3b) of the front decorative cover FC1. In FIGS. 7A and 7B, the snap-fit engaging part 17a has an opening 18 through which the snap-fit engaged part 3 passes, and locking lips 19 which are formed integrally with the cover body 11 in the shape of a cantilever beam at their proximal ends remote from the opening 18 and which are capable of elastic deformation. The lower surfaces of the distal ends of the locking lips 19 are respectively formed with inclined portions 21. Due to the presence of the inclined portions 21, when the snap-fit engaged part 3 passes from the front side (+X side) through the opening 18, the snap-fit engaged part 3 can be reliably guided in the opening 18.

Referring to FIGS. 5B and 6A, a threaded boss receiving groove 22 is defined in the left upper portion (−Y+Z portion) of the cover body 11 at a position which corresponds to the threaded boss 7. At the bottom of the threaded boss receiving groove 22, a screw passage hole (outer cover mounting part) 23 (see FIG. 6A) is defined. Also, an inner operation window 24 is defined in the cover body 11 at a position which corresponds to the outer operation window 1. The user can manually slide an unillustrated cleaner (scorotron cleaning grit cleaner) in the forward and rearward directions through the operation windows 1 and 24.

Referring to FIGS. 4 and 6A, a plurality of reinforcing ribs 26 are formed integrally on the rear surface (inner surface, back surface, −X side surface) of the cover body 11 and the right end wall 12. Further, a slider support part (a functional member, a part support section) which is inclined in the left upward direction is formed integrally on the rear surface of the cover body 11 adjacent to the inner operation window 24. A window cover slider (not shown) for moving a window cover (not shown) which opens and closes the operation windows 1 and 24 is supported by the slider support part 27. When the top cover TC is opened, the user can manipulate the window cover slider (serving as one part) to open the operation windows 1 and 24. Undercut-shaped six release prevention parts 28 are formed adjacent to the rear end (−X side end) of the slide support part 27 to prevent the window cover slider from being released and to hook harnesses inside the printer U. Rapping holes 29 (see FIG. 5B) are defined in the cover body 11 at positions which correspond to the release prevention parts 28.

Further, referring to FIGS. 4 and 6A, an interior protection rib 31 is formed on the left upper portion (−Y+Z portion) of the cover body 11, to protect the inner parts (prevent the user from inadvertently contacting the inner parts and dust, etc. from entering the inside of the printer), when the top cover TC is opened.

In order to ensure that the front strength maintaining member FC2 has necessary strength and the slider is reliably supported, the reinforcing ribs 26 and 31 and the slider guide part 27 are formed to be appropriately positioned and to have a size (thickness, height, etc.), as a result of which indentations are likely to be formed on the outer surface of the cover body 11. The reinforcing ribs 26 according to the preferred embodiment of the present invention are formed to have the same thickness as the cover body 11. However, the thickness of the reinforcing ribs 26 is not limited to the thickness of the cover body 11, and therefore, the reinforcing ribs 26 can be formed thinner or thicker than the cover body 11.

Referring to FIGS. 1, 3 and 4, in the front cover FC according to the preferred embodiment of the present invention, first, the front decorative cover FC1 and the front strength maintaining cover FC2 are overlapped with each other so that the snap-fit engaged parts 3 pass through the openings 18. Then, as the lower surfaces of the clip portions 6a and 6b are engaged with the locking lips 19, a snap-fit engagement structure is accomplished, by which the front decorative cover FC1 and the front strength maintaining cover FC2 are securely coupled to each other. Next, as a screw 31 (see FIG. 4) passes from the inside (−X direction) of the front cover FC through the screw passage hole 23 of the threaded boss receiving groove 22 and then threadably coupled into the threaded hole 8 of the threaded boss 7, it is possible to reliably mount the front decorative cover FC1 to the front strength maintaining cover FC2. With the front decorative cover FC1 mounted to the front strength maintaining cover FC2, the front cover FC is fastened to the frame (not shown) of the printer body U1 by screws which are threadably coupled into the frame-fastening threaded holes 14.

(Description of Rear Cover)

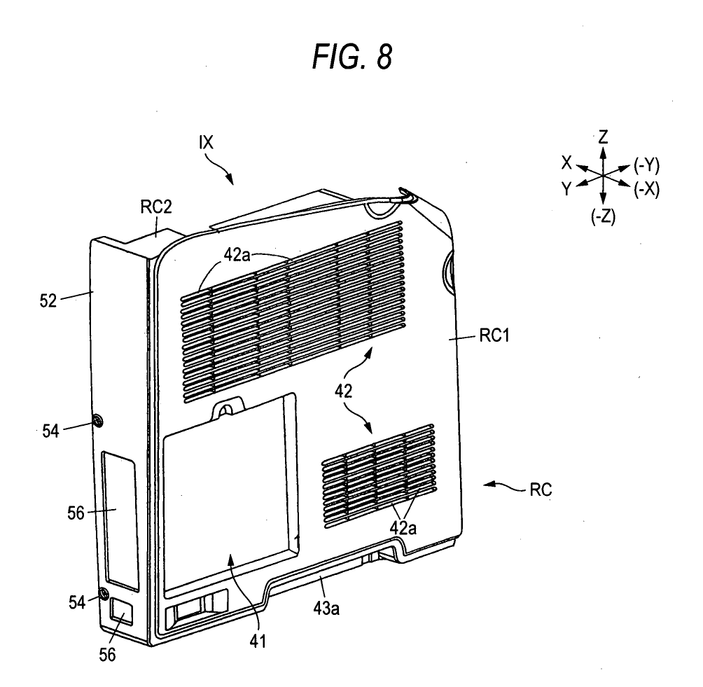

FIG. 8 is a perspective view illustrating a rear cover which constitutes the cover of the image forming apparatus according to the present invention.

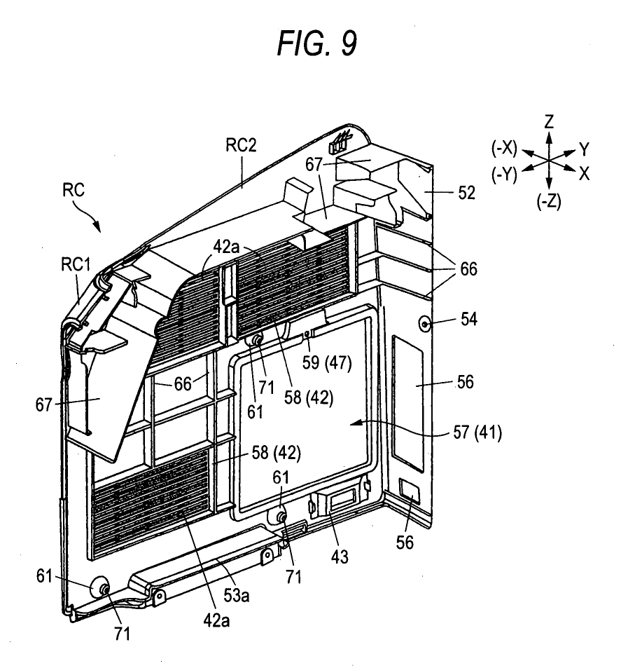

FIG. 9 is a perspective view taken by seeing the rear cover in the direction indicated by the arrow IX.

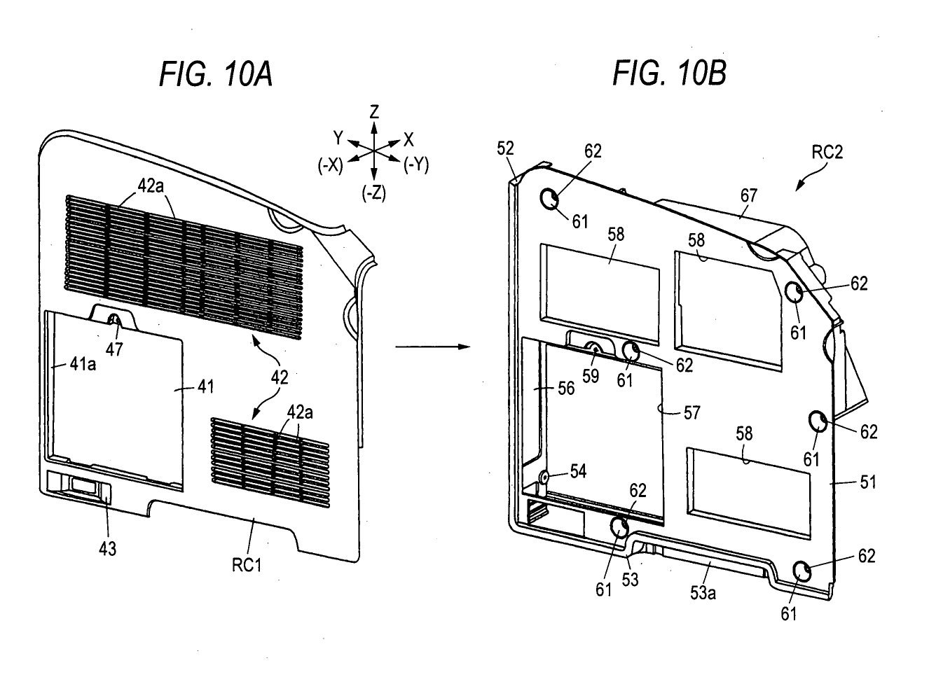

FIGS. 10A and 10B are exploded perspective views of the rear cover, wherein FIG. 10A is an explanatory perspective view illustrating an outer cover, and FIG. 10B is an explanatory perspective view illustrating an inner cover.

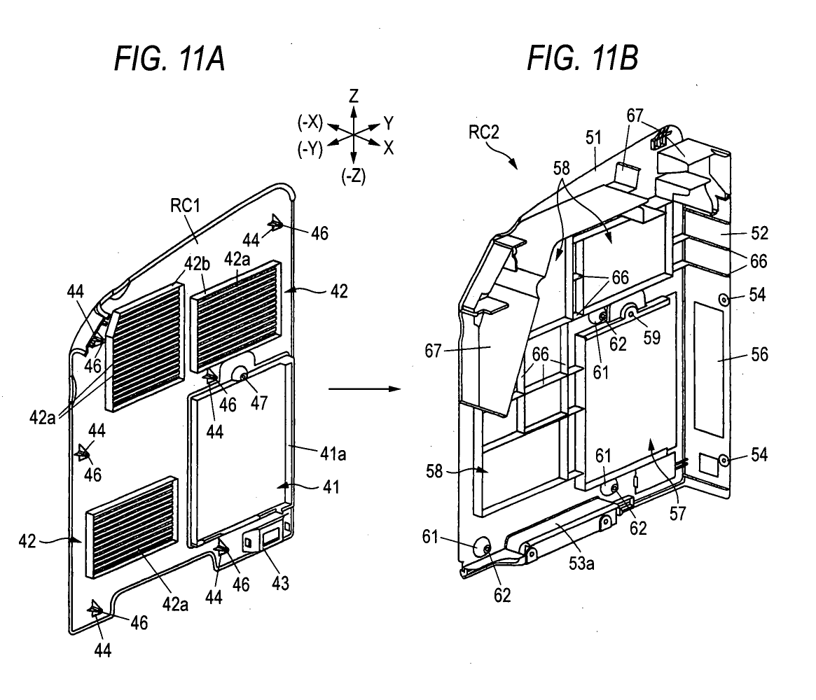

FIGS. 11A and 11B are explanatory exploded perspective views taken by seeing the rear cover from the rear, wherein FIG. 11A is an explanatory perspective view illustrating the outer cover, and FIG. 11B is an explanatory perspective view illustrating the inner cover.

Referring to FIGS. 8 through 11, the rear cover RC includes a rear decorative cover RC1 which serves as an outer cover and a rear strength maintaining cover RC2 which serves as an inner cover. The rear decorative cover RC1 is defined with an outer board manipulation window 41 which passes through the rear decorative cover RC1 in the forward and rearward directions, and a plurality of air vents 42 which are provided with levers 42a. In FIG. 11A, reinforcing ribs 41a and 42b are formed on the inner surface of the rear decorative cover RC1 at the peripheries of the outer board manipulation window 41 and the air vents 42. Also, below the outer board manipulation window 41 of the rear decorative cover RC1, there is defined an opening 43 for a power switch.

Referring to FIG. 11A, six threaded bosses 44 are formed integrally on the back surface (front surface, inner surface) of the rear decorative cover RC1, in the same manner as the threaded boss 7 of the front decorative cover FC1. The respective threaded bosses 44 are defined with threaded holes (mounted parts) 46. A screw passage hole 47 is defined above the outer board manipulation window 41 through the rear decorative cover RC1. In the case that a closure member is provided to close the board manipulation window 41, a screw for fastening the closure member passes through the screw passage hole 47.

Referring to FIGS. 9, 10B and 11B, the rear strength maintaining cover RC2 has a cover body 51, a right end wall 52 (an outer side end) which extends in the forward direction (+X direction) from the right end (+Y side outer end) of the cover body 51, and an edge part 53 which is integrally formed along the lower end of the cover body 51 and projects rearward in conformity with the contour of the lower edge of the rear decorative cover RC1. The right end wall 52 is defined with frame-fastening threaded holes 54 and an access window 56. As in the case of the aforementioned grip portion 13a, a grip portion 53a is formed on the edge part 53 so that the user can grip the grip portion 53a when lifting up the printer U.

Referring to FIGS. 9, 10B and 11B, in the cover body 51, an inner board manipulation window 57 is defined to correspond to the outer board manipulation window 41 of the rear decorative cover RC1, and inner air vents 58 are defined to correspond to the air vents 42. Also, above the inner board manipulation window 57, a threaded hole 59 for the closure member is defined to correspond to the screw passage hole 47 for the closure member. Accordingly, the user or a service engineer can have access through the board manipulation windows 41 and 57 to a control board (not shown) of the printer body U1 which is located adjacent to the rear cover RC, to extend or change a memory or conduct maintenance work. Further, below the inner board manipulation window 57, a through-hole 60 for the power switch is defined in the cover body 51 to correspond to the opening 43 for the power switch.

A threaded boss receiving groove 61 is integrally defined in the cover body 51 at a position which corresponds to the threaded boss 44 of the rear decorative cover RC1, in the same manner as the threaded boss receiving groove 22. At the bottom of the threaded boss receiving groove 61, a screw passage hole (outer cover mounting part) 62 (see FIG. 11B) is defined.

Referring to FIG. 11B, a plurality of reinforcing ribs 66 are formed on the back surface (inner surface) of the cover body 51 and the right end wall 52 to project in the forward and leftward directions. Further, an interior protection rib 67 is formed on the left upper portion (−Y+Z portion) of the cover body 51, to protect the inner parts (prevent the user from inadvertently contacting the inner parts and dust, etc. from entering the inside of the printer), when the top cover TC is opened.

In order to ensure that the rear strength maintaining member RC2 has necessary strength, as in the case of the reinforcing ribs 26 and 31 and the slider support part 27, the reinforcing ribs 66 and the interior protection rib 67 are formed to be appropriately positioned and to have a size (thickness, height, etc.), as a result of which indentations are likely to be formed on the outer surface of the cover body 51. The reinforcing ribs 26 and 66 and the interior protection ribs 31 and 67 according to the preferred embodiment of the present invention are formed to have the same thickness as the cover bodies 11 and 51. However, the thickness of the reinforcing ribs 26 and 66, and the like, is not limited to the thickness of the cover bodies 11 and 51, and therefore, the reinforcing ribs 26 and 66, and the like, can be formed thinner or thicker than the cover bodies 11 and 51.

Referring to FIGS. 8 through 11, in the rear cover RC according to the preferred embodiment of the present invention, first, the rear decorative cover RC1 and the rear strength maintaining cover RC2 are overlapped with each other. Then, as screws 71 (see FIG. 9) threadably pass from the inside (+X direction) of the rear cover RC through the screw passage hole 62 of the threaded boss receiving groove 61 and through the threaded holes 46 of the threaded bosses 44, it is possible to reliably mount the rear decorative cover RC1 to the rear strength maintaining cover RC2. With the rear decorative cover RC1 mounted to the rear strength maintaining cover RC2, the rear cover RC is fastened to the frame (not shown) of the printer body U1 by screws which are threadably coupled into the frame-fastening threaded holes 54.

In the preferred embodiment of the present invention, the strength maintaining covers FC2 and RC2 are made of a flame retarding material, and the decorative covers FC1 and RC1 are made of resin. Also, the decorative covers FC1 and RC1 and the strength maintaining covers FC2 and RC2 are formed integrally by injection molding. The decorative covers FC1 and RC1 are formed to have a thickness which is thinner than that of the cover bodies 11 and 51 of the strength maintaining covers FC2 and RC2.

(Functioning of the Preferred Embodiment)

In the printer U according to the preferred embodiment of the present invention, constructed as mentioned above, the front cover FC and the rear cover RC which serve as the cover have the decorative covers FC1 and RC1 and the strength maintaining covers FC2 and RC2. The decorative covers FC1 and RC1 are mounted to cover the substantially entire surfaces of the strength maintaining covers FC2 and RC2. Accordingly, even though the plurality of reinforcing ribs 26 and 66, the slider support part 27, etc., are formed on the strength maintaining covers FC2 and RC2 and thereby indentations are formed on the outer surfaces of the strength maintaining covers FC2 and RC2, since the entire surfaces of the strength maintaining covers FC2 and RC2 are substantially covered by the decorative covers FC1 and RC1, a user cannot see the indentations, and therefore, the outer appearance of the cover is not deteriorated. As a result, without paying attention to the formation of the indentations, positions and sizes of the reinforcing ribs 26 and 66 and the slider support part 27 of the strength maintaining covers FC2 and RC2 can be designed, whereby design freedom is elevated.

Also, because the decorative covers FC1 and RC1 are mounted to the strength maintaining covers FC2 and RC2, the strength of the decorative covers FC1 and RC1 is not so important. Therefore, the reinforcing ribs 2 and 41a can be decreased in their sizes (or can be removed), and the decorative covers FC1 and RC1 can be decreased in their thicknesses. That is to say, due to the fact that it is possible to freely design the decorative covers FC1 and RC1 without paying attention to strength of the decorative covers FC1 and RC1, and that a size or the number of the reinforcing ribs can be decreased, it is possible to suppress the formation of indentation on the decorative covers FC1 and RC1.

Further, while the strength maintaining covers FC2 and RC2 which serve as the inner cover are made of a flame retarding material for the sake of safety, the decorative covers FC1 and RC1 which serve as the outer cover can be made of a material which is different from that of the strength maintaining covers FC2 and RC2. For this reason, the decorative covers FC1 and RC1 can be manufactured to have various colors or various decorative designs. As a result, since it is possible to elevate freedom in selecting a material for the decorative covers FC1 and RC1, the design freedom and the decoration freedom for the decorative covers can be elevated. In the case that the strength maintaining covers FC2 and RC2 are constructed to be commonly used for various decorative covers, a manufacturing cost of the entire cover can be reduced, and it is possible to vary the outer appearance of the printer U in a diversity of ways.

Because the decorative covers FC1 and RC1 can be attached to and detached from the strength maintaining covers FC2 and RC2, in the case that the decorative covers FC1 and RC1 are damaged or broken, it is sufficient to change only the decorative covers FC1 and RC1, and it is not necessary to change the strength maintaining covers as well. Accordingly, when compared to the conventional art in which the entire cover should be changed, waste of material is avoided, and material reutilization efficiency is improved.

Since the strength maintaining covers FC2 and RC2 can be freely located and improved in its strength without paying attention to the formation of indentations, the grip portions 13a and 53a, to which the entire weight of the printer U is concentrated when the user lifts up the printer U, can be formed on the strength maintaining covers FC2 and RC2.

Further, in the front cover FC according to the preferred embodiment of the present invention, because the front decorative cover FC1 and the front strength maintaining cover RC1 are coupled to each other through snap-fit engagement, a mounting task can be easily conducted. Also, since the snap-fit engagement scheme is adopted, the number of parts including screws can be decreased.

Moreover, by the fact that the outer surfaces of the strength maintaining covers FC2 and RC2 are covered by the decorative covers FC1 and RC1, even when the rapping holes 29 are defined to form the release prevention portions 28 having an undercut shape, since the rapping holes 29 are not viewed by the user, the outer appearance of the cover is not deteriorated. Thus, because specific molds are not needed, which are otherwise needed when forming undercut-shaped portions on a single ply of cover, a manufacturing cost of the strength maintaining covers FC2 and RC2 can be reduced.

(Variations)

Although the preferred embodiment of the present invention was described in detail, the present invention is not limited to that preferred embodiment, and various modifications and changes can be made without departing from the scope and the spirit of the present invention as disclosed in the accompanying claims. Exemplary variations of the present invention will be described below.

(H01) The present invention is not limited to a copying machine and can be applied to other image forming apparatuses such as a printer, a FAX, a document center, and so forth. Also, the present invention is not limited to a monochrome image forming apparatus and can be applied to a color image forming apparatus. Further, the present invention is not limited to an electrophotographic type image forming apparatus and can be applied to an ink jet type image forming apparatus.

(H02) In the above embodiment, while it was described that the reinforcing ribs 26 and 66 and the protective ribs 31 and 67 have the same thickness as the cover bodies 11 and 51, the present invention is not limited to this thickness reference. Therefore, the thicknesses of various component elements can be optionally determined. In the case that the reinforcing ribs 26 and 66 are formed to have a thickness which is the same as that of the cover bodies 11 and 51 or is thinner than the cover bodies 11 and 51 by 20% of the thickness of the cover bodies 11 and 51, the possibility of indentations to be formed is increased.

(H03) In the above embodiment, while the reinforcing ribs 2, 41a and 42b are formed on the decorative covers FC1 and RC1, they can be omitted

(H04) In the above embodiment, while the protective ribs 36 and 67 are formed on the strength maintaining covers FC2 and RC2, they can be omitted.

(H05) In the above embodiment, the decorative cover and the strength maintaining cover which constitute the front cover FC are mounted using the snap-fit engagement structure and the screw fastening structure, and the decorative cover and the strength maintaining cover which constitute the rear cover RC are mounted using the screw fastening structure. However, the present invention is not limited to these mounting schemes. Therefore, only the snap-fit engagement structure or only the screw fastening structure can be adopted or both the snap-fit engagement structure and the screw fastening structure can be adopted. Also, while the snap-fit engaged parts 3 are formed on the front decorative cover FC1 and the snap-fit engaging parts 17 having the openings 18 through which the snap-fit engaged parts 3 pass are formed on the front strength maintaining cover FC2, they can be oppositely formed. That is to say, it can be envisaged that the snap-fit engaged parts 3 are formed on the front strength maintaining cover FC2 and the openings 18 through which the snap-fit engaged parts 3 pass are defined in the front decorative cover FC1. Further, in place of the snap-fit engagement structure and the screw fastening structure, other mounting methods (for example, press-fitting) can be adopted.

(H06) In the above embodiment, the operation windows 1, 24, 41 and 57 and the air vents 42 can be omitted.

(H07) In the above embodiment, while the decorative covers FC1 and RC1 or the strength maintaining covers FC2 and RC2 are made of resin, the present invention is not limited to the use of this material. Therefore, they can be made of a material (for example, magnesium) which can be conventionally used to constitute the cover, or a flame retarding material. Further, while it is preferable that the strength maintaining covers FC2 and RC2 are made of the flame retarding material for the sake of safety, for example, in the case that a member which is heated to a high temperature is not positioned around the strength maintaining covers FC2 and RC2, the flame retarding material may not be used.

(H08) In the above embodiment, the decorative covers FC1 and RC1 or the strength maintaining covers can be manufactured not only by the injection molding method but also by a conventional forming method using various molds (a mold forming method).

(H09) In the above embodiment, while the decorative covers FC1 and RC1 are formed to cover the substantially entire surfaces of the strength maintaining covers FC2 and RC2, the present invention is not limited to this fact. Therefore, the decorative covers FC1 and RC1 can be formed to cover only the portions of the strength maintaining covers FC2 and RC2 on which indentations are likely to be formed (for example, the outer surface portions which correspond to the reinforcing ribs 26 and 66 and the slider support part 27 or the outer surface portions which correspond to the threaded boss receiving grooves 22 and 61). In addition, each of the decorative covers FC1 and RC1 is not limited to a single ply of cover element and may include a plurality of parts.

(H10) In the above embodiment, while the threaded holes for fastening the covers FC and RC to the image forming apparatus U (the frame-fastening threaded holes 14 and 54) are defined in the right end walls 12 and 52, the present invention is not limited to these positions. Hence, threaded bosses, which are defined with threaded holes (configured in the same manner as the threaded boss receiving grooves 22 and 61), can be formed on the cover bodies 11 and 51 of the strength maintaining covers FC2 and RC2. AS the relatively large covers FC and RC are mounted to the image forming apparatus U, the size of the threaded holes may be substantial, and sizes of the threaded bosses and the ribs for the threaded bosses may also be substantial, by which indentations are likely to be formed on the outer surfaces of the strength maintaining covers FC2 and RC2. However, in the present invention, since the outer surfaces of the strength maintaining covers FC2 and RC2 are covered by the decorative covers FC1 and RC1, the outer appearance of the cover is prevented from being deteriorated, and it is possible to freely design sizes, positions, etc., of the threaded bosses.

(H11) In the above embodiment, while the slider support part is exemplified as the part support section, it is not necessary to slidably support parts. In the case of fixedly supporting the parts of the image forming apparatus, threaded holes can be defined to serve as the part support section, and in the case of rotatably supporting the parts of the image forming apparatus, rotation shafts or shaft passage holes can be formed or defined to serve as the part support section.

What is claimed is:

1. A cover comprising:
an inner cover for an image forming apparatus, including: a integrally formed reinforcing rib for improving strength; and a outer cover mounting part; and
an outer cover including a mounted part which is mounted to the outer cover mounting part, wherein
the outer cover possesses an outer surface which is exposed to the outside when the mounted part is mounted to the outer cover mounting part.

2. The cover according to claim 1, wherein
the inner cover is formed by molding.

3. The cover according to claim 1, wherein
the inner cover is made of resin.

4. The cover according to claim 1, wherein:
the outer cover has the mounted part which is defined with a threaded hole; and
the inner cover has the outer cover mounting part which is defined with a screw passage hole so that the outer cover is mounted to the inner cover by a screw which passes through the screw passage hole and the threaded hole from the inside of the inner cover.

5. The cover according to claim 1, wherein:
the inner cover has the outer cover mounting part which includes a snap-fit engaging part; and
the outer cover has the mounted part which includes a snap-fit engaged part so that the outer cover is mounted to the inner cover through engagement of the snap-fit engaged part with the snap-fit engaging part when the outer cover is overlapped with the inner cover.

6. The cover according to claim 1, wherein
the outer cover covers a substantially entire surface of the inner cover when the outer cover is mounted to the inner cover.

7. The cover according to claim 1, wherein
the inner cover is defined with a rapping hole for rapping during integral formation.

8. The cover according to claim 1, wherein
the inner cover is fastened to a frame of the image forming apparatus with the outer cover mounted to the inner cover.

9. The cover according to claim 1, wherein
the inner cover is defined at an outer end thereof with a frame-fastening threaded hole into which a screw for fastening the inner cover to the frame is threadably coupled.

10. The cover according to claim 1, wherein
the inner cover has a part support section for supporting parts which constitute the image forming apparatus.

11. The cover according to claim 10, wherein
the outer cover covers an outer surface portion of the inner cover, which corresponds to a position where the part support section is installed.

12. The cover according to claim 1, wherein
the inner cover has the reinforcing rib which has a thickness thicker than that of the outer cover.

13. The cover according to claim 1, wherein
the outer cover covers an indentation which is formed on an outer surface portion of the inner cover due to the presence of the reinforcing rib which is integrally formed.

14. The cover according to claim 1, wherein:
the inner cover has a threaded boss which is defined with a threaded hole for mounting the inner cover to the image forming apparatus; and
the outer cover covers an outer surface portion of the inner cover, which corresponds to a position where the threaded boss is formed.
